(19) United States
(12) Patent Application Publication
(10) Pub. No.: US 2014/0335870 A1
(43) Pub. Date: Nov. 13, 2014

(54) METHOD AND APPARATUS FOR CONTROLLABLY HANDING OVER A MOBILE TERMINAL TO A SMALL CELL WITHIN A HETEROGENEOUS NETWORK

(71) Applicant: Nokia Corporation, Espoo (FI)

(72) Inventors: Osman Nuri Can Yilmaz, Helsinki (FI); Carl Simon Wijting, Espoo (FI); Jari Petteri Lunden, Espoo (FI)

(21) Appl. No.: 14/365,815

(22) PCT Filed: Dec. 23, 2011
(86) PCT No.: PCT/IB2011/055950

§ 371 Date: Jun. 16, 2014

(51) Int. Cl. H04W 36/32

(52) U.S. Cl. CPC H04W 36/32
USPC 455/441

(57) ABSTRACT

A method, apparatus and computer program product are provided for controlling the handover of a mobile terminal, particularly a quickly moving mobile terminal, to a small cell. In the method, the speed or the mobility state of the mobile terminal is determined. The method may also determine whether at least a predefined plurality of small cells are available in proximity to the mobile terminal. If the mobile terminal is moving with a speed that satisfies the speed threshold or the mobility state satisfies a predefined criteria, the method causes initiation of a handover of the mobile terminal to a respective small cell only in an instance in which at least the predefined plurality of small cells are determined to be available in proximity to the mobile terminal or in which a successful connection or handover was previously established with the respective small cell or its neighboring small cell(s).

### TECHNOLOGICAL FIELD

An example embodiment relates generally to the handover of a mobile terminal to a small cell and, more particularly, to the handover of a mobile terminal to a small cell within a heterogeneous network in instances in which the handover is determined to be appropriate.

### BACKGROUND

Heterogeneous networks include a plurality of cells of different sizes. These cells may include, for example, macro cells, such as Node Bs, evolved Node Bs (eNBs) or the like, as well as small cells, such as microcells, femtocells, picocells, home Node Bs (HNBs), home evolved Node Bs (HeNBs) and the like. The small cells of a heterogeneous network provide offloading opportunities for high data rates and other services so as to free up the macrocells to support other types of traffic. The offloading of at least some services to small cells is becoming of increased importance as networks, including heterogeneous networks, are subjected to increased demands for data throughput.

The cells of a heterogeneous network maybe co-channeled cells of different sizes which may, in turn, raise interference issues. Alternatively, the cells of a heterogeneous network may operate on different frequency layers, such as in an instance in which the macrocells operate on a different frequency layer than the small cells. By utilizing cells on different frequency layers, a mobile terminal need not necessarily be connected to the strongest cell since there will not be co-channel interference between the different frequency layers of the network. Thus, a heterogeneous network in which the macrocells and the small cells are on different frequency layers may provide more flexibility in regards to the cell to which a mobile terminal is connected, thereby permitting a mobile terminal to be handed over to a small cell even if the small cell is not stronger than the macrocell.

However, it may be relatively difficult in a heterogeneous network to determine the appropriate cell and/or the appropriate frequency layer to which a mobile terminal should be connected. In this regard, a cell to which the mobile terminal is connected should provide the desired quality of service (QoS) and robust mobility in order to obtain the desired offloading benefits. Moreover, the quality of service and the robust mobility of the connection should be maintained even as a mobile terminal is moved from a macrocell to a small cell and also when the mobile terminal is returned from a small cell to a macrocell.

The challenges associated with maintaining the desired quality of service and providing the robust mobility as a mobile terminal is connected to a small cell in one frequency layer and, in turn, to a macrocell on another frequency layer may be exacerbated in an instance in which the mobile terminal is moving relatively quickly, at least with respect to the size of the cells serving the mobile terminal. In this regard, the frequent handovers that may be caused by the relatively fast movement of the mobile terminal may cause undesirable connection gaps and, in some instances, radio link failures if there is not sufficient time for the mobile terminal to perform a handover from the small cell supporting the mobile terminal to a macrocell on another frequency layer.

### BRIEF SUMMARY

A method, apparatus and computer program product are therefore provided according to an example embodiment of the present invention for controlling the handover of a mobile terminal to a small cell within a heterogeneous network so as to maintain the desired quality of service, even in an instance in which the mobile terminal is moving relatively quickly. As such, the method, apparatus and computer program product of the example embodiment may reduce connection gaps and radio link failures that may otherwise be created by inter-frequency handovers of a mobile terminal from a small cell to a macrocell in an instance in which a mobile terminal is moving rapidly. Thus, the method, apparatus and computer program product of an example embodiment may improve the user experience while still taking advantage of the offloading opportunities for high data rate and other services that are offered by a heterogeneous network.

In one embodiment, a method is provided that includes determining the speed with which a mobile terminal is moving or a mobility state of the mobile terminal. The method may also determine whether at least a predefined plurality of small cells, such as femtocells, picocells, microcells, home Node Bs or a home evolved Node Bs, are available in proximity to the mobile terminal or whether a successful connection or handover was previously established with a small cell or one or more of its neighboring small cells. In an instance in which the mobile terminal is moving with a speed that satisfies the speed threshold or in which the mobility state satisfies a predefined criteria, the method may cause initiation of a handover of the mobile terminal to a respective small cell only in an instance in which at least the predefined plurality of small cells are determined to be available in proximity to the mobile terminal or in an instance in which a successful connection or handover was previously established with the respective small cell or one or more of its neighboring small cells. In one embodiment, initiation of a handover may be caused by causing a report (for example, a proximity indication) to be issued to a network element that identifies the respectively small cell.

The method may define the speed threshold based upon a size of the respective small cell and/or a minimum connection time. The method of one embodiment may also determine, for an application executing upon the mobile terminal, at least one of a sensitivity of the application to delay or an anticipated service time for the application such that initiation of the handover of the mobile terminal is also based upon a determination of at least one of a sensitivity of the application to delay or an anticipated service time for the application. The method of one embodiment may also include causing initiation of a handover of the mobile terminal to a respective small cell in an instance in which at least a predefined time period has elapsed since an unsuccessful connection and/or handover was previously established with the respective small cell and its neighboring small cell(s). The method may also include causing initiation of a handover of the mobile terminal to a respective small cell in an instance in which a ratio of a number of successful connections and/or handovers that were previously established with the respective small cell and its neighboring small cell(s) to a number of unsuccessful connections and/or handovers that were previously established with the respective small cell and its neighboring small cell(s) satisfies a predefined threshold. A method of one embodiment may also include causing initiation of a handover of the mobile terminal to a respective small cell in an instance in which a connection and/or a handover with the respective small cell and its neighboring small cell(s) would have previously been successful even though no connection and/or handover with the respective small cell and its neighboring small cell(s) has been previously established.

In another embodiment, an apparatus including at least one processor and at least one memory including a computer program code with the at least one memory and the computer program code being configured to, with the at least one processor, cause the apparatus at least to determine a speed with which the mobile terminal is moving or a mobility state of the mobile terminal. The at least one memory and the computer program code are also configured to, with the at least one processor, cause the apparatus at least to determine whether at least a predefined plurality of small cells, such as femtocells, picocells, microcells, home Node Bs or home evolved Node Bs, are available in proximity to the mobile terminal or whether a successful connection or handover was previously established with a small cell or one or more of its neighboring small cells. The at least one memory and the computer program code are also configured to, with the at least one processor, cause the apparatus at least to cause initiation of a handover of the mobile terminal, in an instance in which the mobile terminal is moving at a speed that satisfies a speed threshold or in which the mobility state satisfies a predefined criteria, to a respective small cell only in an instance in which at least the predefined plurality of small cells are determined to be available in proximity to the mobile terminal or in an instance in which a successful connection or handover was previously established with the respective small cell or one or more of its neighboring small cells. The at least one memory and the computer program code may, in one embodiment, also be configured to, with the at least one processor, cause the apparatus to cause initiation of a handover by causing a report to be issued to a network element that identifies the respective small cell.

The at least one memory and the computer program code may also be configured to, with the at least one processor, cause the apparatus to define the speed threshold based upon the size of the respective small cell and/or a minimum connection time. The at least one memory and the computer program code may also be configured to, with the at least one processor, cause the apparatus to determine, for an application executing upon the mobile terminal, at least one of a sensitivity of the application to delay or an anticipated service time for the application such that initiation of the handover of the mobile terminal is also based upon a determination of at least one of a sensitivity of the application to delay or an anticipated service time for the application. The at least one memory and the computer program code may also be configured to, with the at least one processor, cause the apparatus to cause initiation of a handover of the mobile terminal to the respective small cell in an instance in which at least a predefined time period has elapsed since an unsuccessful connection and/or handover was previously established with the respective small cell and its neighboring small cell(s), in an instance in which a ratio of a number of successful connections and/or handovers that were previously established with the respective small cell and its neighboring small cell(s) to a number of unsuccessful connections and/or handovers that were previously established with the respective small cell and its neighboring small cell(s) satisfies a predefined threshold, and/or in an instance in which a connection and/or handover with the respective small cell and its neighboring small cell(s) would have previously been successful even though no connection and/or handover with the respective small cell and its neighboring small cell(s) has previously been established.

In a further embodiment, a computer program product including at least one computer-readable storage medium having computer-executable program code portions stored therein may be provided with the computer-executable program code portions including program instructions configured to determine the speed with which the mobile terminal is moving or a mobility state of the mobile terminal. The computer-executable program code portions may also include program instructions configured to determine whether at least a predefined plurality of small cells, such as femtocells, picocells, microcells, home Node Bs or home evolved Node Bs, are available in proximity to the mobile terminal or whether a successful connection or handover was previously established with a small cell or one or more of its neighboring cells. The computer-executable program code portions also include program instructions configured to cause initiation of a handover of the mobile terminal, in an instance in which the mobile terminal is moving with a speed that satisfies the speed threshold or in which the mobility state satisfies a predefined criteria, to a respective small cell only in an instance in which at least the predefined plurality of small cells are determined to be available in proximity to the mobile terminal or in an instance in which a successful connection or handover was previously established with the respective small cell or one or more of its neighboring small cells. In one embodiment, the program instructions configured to cause initiation of a handover may include program instructions configured to cause a report to be issued to a network element that identifies the respective small cell.

The computer-executable program code portions may also include program instructions configured to define the speed threshold based upon the size of the respective small cell and/or a minimum connection time. The computer-executable program code portions may also include program instructions configured to determine, for an application executing upon the mobile terminal, at least one of a sensitivity of the application to delay or an anticipated service time for the application such that the initiation of the handover of the mobile terminal is also based upon a determination of at least one of a sensitivity of the application to delay or an anticipated service time for the application. The computer-executable code portions may also include program instructions configured to cause initiation of a handover of the mobile terminal to a respective small cell in an instance in which at least a predefined time period has elapsed since an unsuccessful connection and/or handover was previously established with the respective small cell or its neighboring small cell(s), in an instance in which a ratio of a number of successful connections and/or handovers that were previously established with the respective small cell and its neighboring small cell(s) to a number of unsuccessful connections and/or handovers that were previously established with the respective small cell and its neighboring small cell(s) satisfies a predefined threshold and/or in an instance in which a connection and/or handover with the respective small cell and its neighboring small cell(s) would have previously been successful even though no connection and/or handover with the respective small cell and its neighboring small cell(s) has previously been established.

In yet another embodiment, an apparatus is provided that includes means for determining a speed with which a mobile terminal is moving or a mobility state of the mobile terminal. The apparatus of this embodiment may also include means for determining whether at least a predefined plurality of small cells are available in proximity to the mobile terminal or whether a successful connection or handover was previously established with a small cell or one or more of its neighboring small cells. In an instance in which the mobile terminal is moving with the speed that satisfies the speed threshold or in which the mobility sate satisfies a predefined criteria, the apparatus of this embodiment may also include means for causing initiation of a handover of the mobile terminal to a respective small cell only in an instance in which at least the predefined plurality of small cells are determined to be available in proximity to the mobile terminal or in an instance in which a successful connection or handover was previously established with the respective small cell or one or more of its neighboring small cells.

### BRIEF DESCRIPTION OF THE SEVERAL VIEWS OF THE DRAWINGS

Having thus described embodiments of the present disclosure in general terms, reference will now be made to the accompanying drawings, which are not necessarily drawn to scale, and wherein:

FIG. 1 is a schematic representation of a heterogeneous network that includes one or more macro cells and a plurality of small cells;

FIG. 2 is a block diagram of an apparatus that may be configured in accordance with one embodiment of the present invention; and

FIGS. 3A and 3B are block diagrams of the operations that may be performed in accordance with one embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

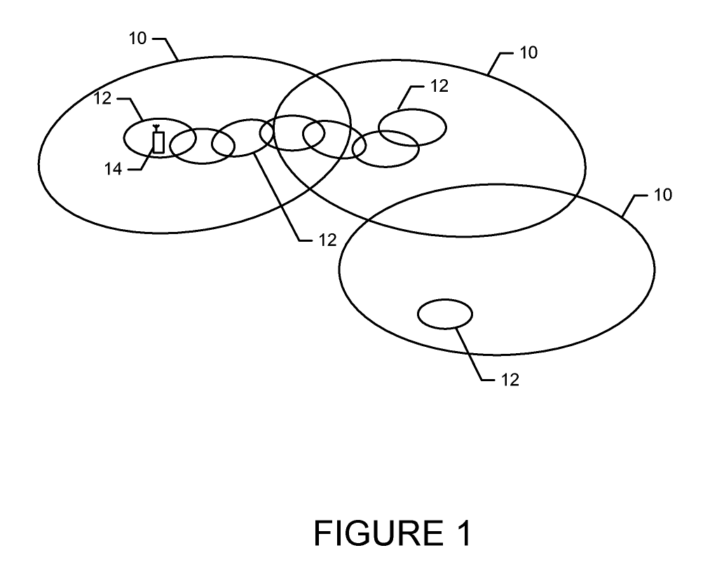

Referring now to FIG. 1, a heterogeneous network is illustrated. As shown, the heterogeneous network includes one or more macrocells 10, such as node Bs, evolved node Bs or other types of access points that are configured to serve a relatively large area. The heterogeneous network also includes a plurality of small cells 12. Each small cell generally serves and supports communications with mobile terminals within a smaller area than that served by the macro cells. In other words, the small cells have a cell area that is less than that of the macro cells. The heterogeneous network may include various types of small cells including, for example, microcells, femtocells, picocells, home node Bs, home evolved node Bs, or the like. In one embodiment, the macro cells operate on a different frequency layer than the small cells.

Cell size may refer to the general size and transmit power of the cell which, in turn, is related to the physical size of the coverage area of the cell. The cell size may be known based on broadcast information by the cell, or may be obtained from a database which may be stored locally by a mobile terminal 14 or by the network. The cell size may also or alternatively be known based on configuration information from the network that may indicate that one or more cell identifiers (IDs) correspond to small cells or that may indicate one or more carriers on which small cells operate.

As shown in FIG. 1, a mobile terminal 14 that is moving throughout the heterogeneous network may be located, at least temporarily, within a region that is served by both one or more macro cells 10 and one or more small cells 12. In some instances, such as in instances in which the mobile terminal is utilizing high data rate or other services, it may be desirable to offload support of the mobile terminal from a macro cell to one or more small cells, thereby permitting the macro cells to service other mobile terminals without being limited by the throughput that might otherwise be created by the high data rate or other services of the mobile terminal.

The mobile terminal 14 may be any of numerous different types, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of voice and text communications systems, may readily employ an example embodiment of the present invention.

As described below, the method, apparatus and computer program product of an example embodiment of the present invention do not blindly hand over the mobile terminal 12 from a macro cell 10 to a small cell 12, or from a small cell to a macro cell since the transition between the macro cell and the small cell, particularly in instances in which the macro cell and the small cell operate in different frequency layers, has the potential to cause a connection gap or a radio link failure in certain instances, such as in instances in which the mobile terminal is moving relatively quickly in comparison to the size of the small cell such that the hand over may not occur quickly enough to maintain continuous communications. As such, the method, apparatus and computer program product may analyze one or more conditions, such as the speed with which the mobile terminal is moving and the number of small cells that are in the proximity of the mobile terminal prior to initiating a hand over of the mobile terminal from a macro cell to a small cell in an effort to reduce, or eliminate, connection gaps and instances of radio link failure.

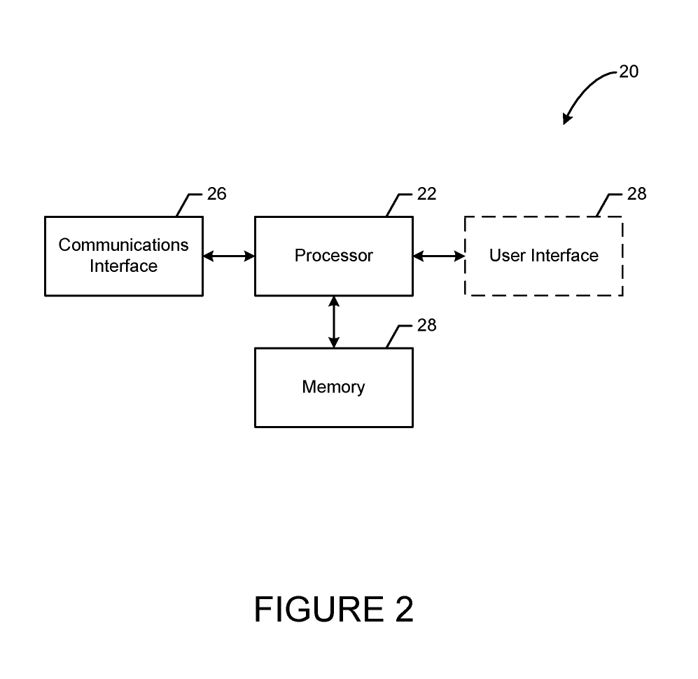

The apparatus may be embodied by any one of a number of different devices including, for example, the mobile terminal 14 or a network element. Regardless of the manner in which the apparatus is embodied, the apparatus 20 may generally be configured as shown, for example, in FIG. 2. In this embodiment, the apparatus may include or otherwise be in communication with a processor 22, a memory device 24, a communications interface 26 and a user interface 28. In some embodiments, the processor (and/or co-processors or any other processing circuitry assisting or otherwise associated with the processor) may be in communication with the memory device via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, applications, instructions or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 20 may, in some embodiments, be a mobile terminal 14 or a network element configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or network device) adapted for employing an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 26 may be any means such as a device or circuitry embodied in either hardware, software, or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The user interface 28 may be in communication with the processor 22 to receive an indication of a user input at the user interface and/or to provide an audible, visual, mechanical or other output to the user. As such, the user interface may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface may be limited, or eliminated. However, in an embodiment in which the apparatus is embodied as a communication device (e.g., the mobile terminal 14), the user interface may include, among other devices or elements, any or all of a speaker, a microphone, a display, and a keyboard or the like. In this regard, for example, the processor may comprise user interface circuitry configured to control at least some functions of one or more elements of the user interface, such as, for example, a speaker, ringer, microphone, display, and/or the like. The processor and/or user interface circuitry comprising the processor may be configured to control one or more functions of one or more elements of the user interface through computer program instructions (e.g., software and/or firmware) stored on a memory accessible to the processor (e.g., memory device 24, and/or the like).

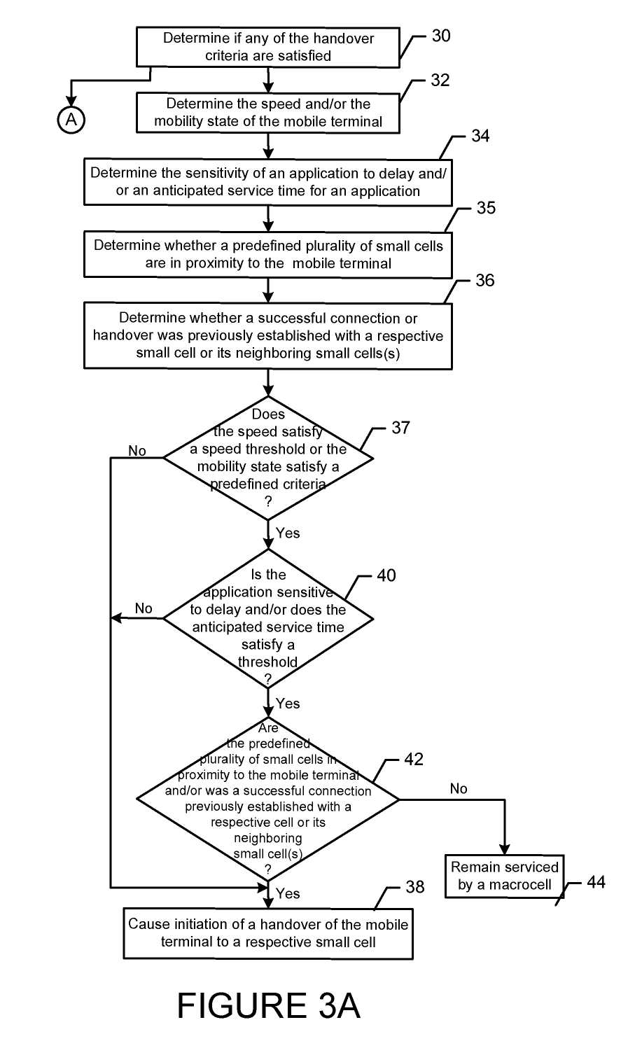

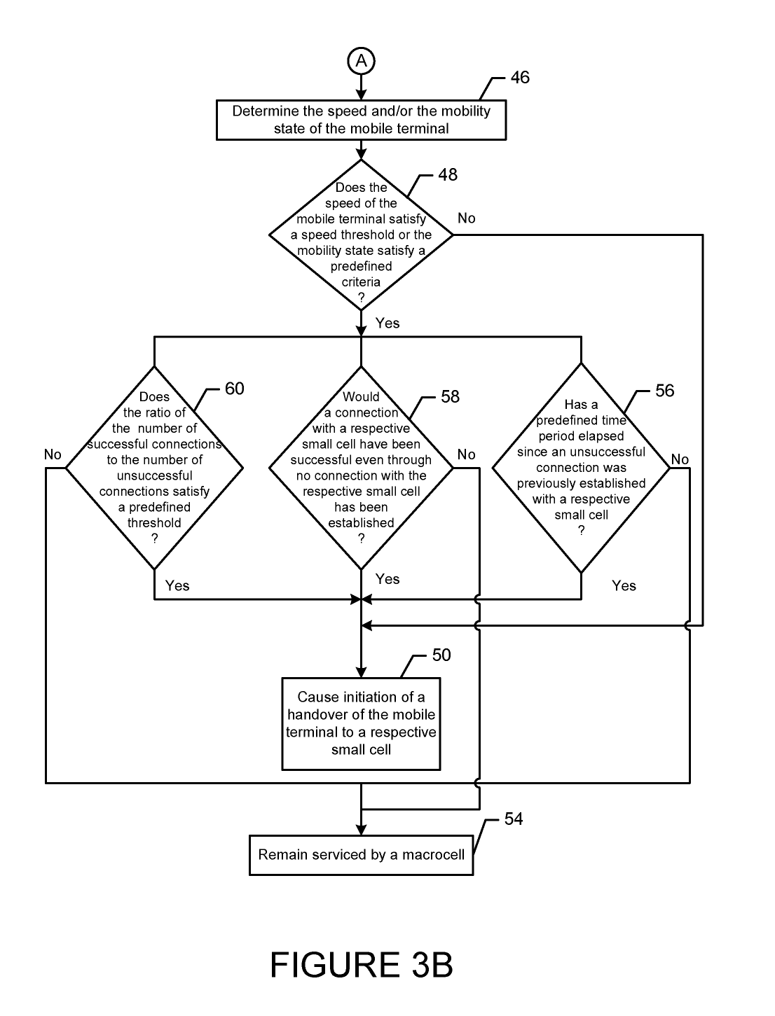

As shown in block 30 of FIG. 3A, in an instance in which one or small cells 12 are available to service a respective mobile terminal 14, the apparatus 20 may include means, such as the processor 22 or the like, for determining whether a predefined criteria that must be met prior to initiating hand over to the small cell has been met. Various criteria may be defined such that the satisfaction of the criteria results in there being a reasonable likelihood that a hand over to a small cell will result in a successful connection to the small cell without a connection gap or a radio link failure.

In accordance with an example embodiment, one criterion may be based upon the speed with which a mobile terminal 14 is moving and a number of small cells 12 that are available in proximity to the mobile terminal. In this regard, the apparatus 20 may include means, such as the processor or the like, for determining the speed with which the mobile terminal is moving. See operation 32 of FIG. 3A. The speed may be determined in various manners. For example, the speed with which the mobile terminal is moving may be defined as the velocity with which the mobile terminal is moving, such as determined utilizing global positioning system (GPS)-based estimation and/or Doppler shift, based accelerometer sensor data. However, the speed may also or alternatively be estimated in other manners including, for example, by the number of cell-reselections and/or hand overs, based upon the rate of change of the signal strength as measured from a cellular base stations or a Wi-Fi access point, or the like.

As also shown in operation 32 of FIG. 3A, an additional or alternative criterion may be based upon the mobility state of the mobile terminal 14 and a number of small cells 12 that are available in proximity to the mobile terminal. In this regard, the mobility state of the mobile terminal may be identified, such as stationary, low mobility or high mobility in one example or simply either stationary or moving in another example. The mobility state may be determined, such as by the processor 22 of the mobile terminal, as a rough characterization of the speed of the mobile terminal or based on the number of cell reselections, changes or handovers that the mobile terminal experienced within a predetermined time window.

The apparatus 20 of one embodiment may also include means, such as the processor 22 or the like, for determining, for an application executing upon the mobile terminal, the sensitivity of the application to delay and/or the anticipated service time for the application. See block 34 of FIG. 3A. The sensitivity of an application to delay is a measure of the delay in data processing, transmission or the like, that may be incurred while still permitting the application to function properly. The sensitivity of the application to delay may be defined in various manners. For example, each application may be indicated to be either sensitive to delay or insensitive to delay. Alternatively, or additionally, for the applications that are sensitive to delay, the degree of sensitivity may be defined for the respective applications, such as very sensitive to delay, moderately sensitive to delay, minimally sensitive to delay, or the like. As such, the apparatus, such as a processor, may be configured to determine the sensitivity of an application that is executing upon the mobile terminal to delay by accessing and considering information associated with the application that defines the sensitivity of the application to delay.

As to the anticipated service time for the application, the anticipated service time, such as the average length of time that an application remains active, may be predefined and similarly associated with the application. Thus, the apparatus 20, such as a processor 22, may determine the anticipated service time based upon the predefined time value that has been associated with the application.

As shown in block 35 of FIG. 3A, the apparatus 20 may also include means, such as the processor 22, the communication interface 26 or the like, for determining whether at least a predefined plurality of small cells 12, such as two or more small cells, are available in proximity to the mobile terminal 14. In this regard, the small cells may each operate on the same frequency layer, although generally on a different frequency layer than the macro cell 10. In this regard, the small cells on the same frequency layer may be detected based on the signal strength of the small cells at the same carrier and/or based on predefined or stored information regarding the location and/or coverage area of the cells. In determining the availability of at least the predefined plurality of small cells, the apparatus, such as the processor, the communication interface or the like, of this embodiment may determine whether at least the predefined plurality of small cells are available to service the mobile terminal.

The apparatus 20 of one embodiment may also or alternatively include means, such as the processor 22 or the like, for determining whether the mobile terminal 14 has detected a small cell 12 with which the mobile terminal has previously had a successful connection or handover either with the small cell or its neighboring small cell(s). See block 36 of FIG. 3A. In one example, the apparatus, such as the memory 24, may maintain the connection history or at least the recent connection history of the mobile terminal. A successful connection may be defined in various manners, but, in one embodiment, is defined to be a connection to a small cell that lasts longer than a predefined threshold, such as twenty seconds, or a connection to a small cell that was immediately preceded by the connection of a mobile terminal to another small cell or that was immediately followed by the connection of the mobile terminal to another small cell, thereby evidencing the capability of the mobile terminal to be handed over between small cells.

In this embodiment, the apparatus 20 may also include means, such as the processor 22 or the like, for determining whether the mobile terminal 14 is moving with a speed that satisfies a speed threshold. See block 37 of FIG. 3A. The speed threshold may be defined in various manners including as a predefined value, e.g., 10 km/h. In one embodiment, the speed threshold is defined by the processor based upon the size of a respective small cell 12 and/or a minimum connection time. In this regard, the speed threshold may be defined to be the maximum speed with which a mobile terminal may be moving that would still require the mobile terminal to spend at least a predefined period of time within the small cell while the mobile terminal moves across the small cell. In regard to the speed threshold being a predefined value, different predefined values may be defined for differently sized cells. For example, a picocell may have a higher speed threshold than a home evolved node B since a picocell may have a larger cell size than a home evolved node B.

By way of example, the speed threshold may be set such that it would typically take the mobile terminal 14 longer than the minimum connection time to cross the coverage area of the small cell 12. In this regard, minimum connection time is the minimum length of a useful connection to the small cell, that is, how long the connection needs to be to benefit from performing the handover to the small cell. The minimum connection time may therefore depend upon the typical handover delay and the length of service disruption during handover, that is, the minimum connection time should exceed the typical handover delay and the length of service disruption during handover. Additionally or alternatively, the minimum connection time may be based on the application requirements of one or more applications being executed by the mobile terminal.

As shown in block 37 of FIG. 3A, the apparatus 20 may also include means, such as the processor 22 or the like, for determining whether the mobility state of the mobile terminal 14 satisfies a predefined criteria. Various criteria may be predefined. For example, the predefined criteria may be that the mobile terminal is moving and not stationary. Alternatively, the predefined criteria may be that the mobility state is high mobility and not stationary or low mobility.

In an instance in which the speed with which the mobile terminal 14 is moving fails to satisfy the speed threshold, such as by being smaller than the speed threshold, and in which the mobility state of the mobile terminal fails to satisfy the predefined criteria, the apparatus 20 may include means, such as the processor 22, the communication interface 26 or the like, for causing initiation of a hand over of the mobile terminal to a respective small cell 12. See block 38 of FIG. 3A. In this regard, the mobile terminal may be handed over to the small cell since the mobile terminal is not moving at such a high speed as to cause any meaningful risk that the mobile terminal will quickly move outside the cell area of the small cell and require a further hand over, such as a hand over to the macro cell, which may, in turn, create the risk of a connection gap or a radio link failure if the mobile terminal had been moving quickly.

However, in an instance in which the speed with which the mobile terminal 14 is moving satisfies the speed threshold or in which the mobility state of the mobile terminal satisfies the predefined criteria, the apparatus 20 of one embodiment may include means, such as the processor 22 or the like, for determining if the sensitivity of the application to delay and/or the anticipated service time of the application satisfy predefined criteria. See block 40 of FIG. 3A. In this regard, the apparatus, such as a processor, may determine whether the application that is executing upon the mobile terminal is sensitive to delay. If the application is insensitive to delay or if the sensitivity of the application to delay is less than a predefined level of sensitivity, the apparatus may include means, such as the processor, the communication interface 26 or the like, for causing the initiation of a hand over of the mobile terminal to a respective small cell 12 since any delays that may be associated with a subsequent hand over of the global terminal to a macro cell 10 would not appear to impair the execution of the application. See block 38 of FIG. 3A.

Additionally, or alternatively, the apparatus 20 such as a processor 22, may determine if the anticipated service time for the application that is executing upon the mobile terminal 14 satisfies a predefined threshold. In this regard, in an instance in which the mobile terminal determines that the anticipated service time is less than the predefined threshold, the apparatus, such as a processor, communication interface 26 or the like, may cause initiation of a hand over of the mobile terminal to a respective small cell 12 since the anticipated service time is short enough that the application will likely have completed its execution prior to requiring any further hand over to a macro cell 10.

In instances in which the speed with which the mobile terminal 14 is moving satisfies a speed threshold or in which the mobility state of the mobile terminal satisfies a predefined criteria and optionally based upon the sensitivity of the application to delay and/or the anticipated service time of the application, the apparatus 20 may include means, such as the processor 22, the communication interface 26 or the like, for causing initiation of a hand over of the mobile terminal to a respective small cell 12 only in an instance in which at least the predefined plurality of small cells are determined to be available in proximity to the mobile terminal or in which a successful connection or handover was previously established with the respective small cell or its neighboring small cell(s). See blocks 42 and 38 of FIG. 3A. For example, in instances in which the speed with which the mobile terminal is moving satisfies a speed threshold and the application is sensitive to delay and/or the anticipated service time exceeds a predefined threshold, the apparatus, such as the processor, the communication interface or the like, may be configured to cause initiation of a hand over of the mobile terminal to a respective small cell only in an instance in which at least the predefined plurality of small cells are determined to be available in proximity to the mobile terminal. By limiting the instances in which the mobile terminal may be handed over to a respective small cell to those in which at least the predefined plurality of small cells are determined to be available to the mobile terminal or in which a successful connection or handover was previously established with the respective small cell or its neighboring small cell(s), the mobile terminal may reduce the risks associated with a connection gap or a radio link failure since the mobile terminal may be handed over from one small cell to another small cell within the same frequency layer if so required by the movement of the mobile terminal relative to the small cells without requiring hand over to a macro cell 10 in a different frequency layer as quickly, thereby deferring the risks associated with a connection gap or radio link failure that is created by the hand over to another frequency layer.

In this embodiment, in instances in which the mobile terminal 14 is moving with a speed that satisfies a speed threshold or has a mobility state that satisfies a predefined criteria and optionally based upon the sensitivity of the application to delay and/or the anticipated service time of the application, the apparatus 20, such as the processor 22, the communication interface 26 or the like, may not initiate hand over of the mobile terminal if only one or no small cells 12 are determined to be in the proximity of the mobile terminal and there was no prior successful connection or handover with the respective small cell or its neighboring small cell(s) with the mobile terminal, instead, continuing to be serviced by the macro cell 10. See block 44 of FIG. 3A. For example, in instances in which the mobile terminal is moving with a speed that satisfies a speed threshold and the application is sensitive to delay and/or the anticipated service time exceeds a predefined threshold, but only one or none small cells are determined to be available and there was no prior successful connection or handover with the respective small cell or its neighboring small cell(s), the apparatus, such as the processor, the communication interface or the like, may not initiate hand over of the mobile terminal.

As noted above, the apparatus 20 may be embodied by various devices including the mobile terminal 14 or a network element, such as a base station. In instances in which the apparatus is embodied by the mobile terminal, the apparatus may cause initiation of a hand over of the mobile terminal to a respective small cell 12 by causing a report to be issued to the network element that identifies both the mobile terminal and the respective small cell, such as by means of a physical cell identifier (PCI) and other information such as the reference signal received power (RSRP), the velocity of the mobile terminal, etc. Based upon the information that identifies the mobile terminal and the respective small cell, the network element may then cause the mobile terminal to be handed over to the respective small cell. In an instance in which the mobile terminal determines that a handover should not be made, the mobile terminal need not send handover-related reports to the network element, such as the macrocell, so that the macrocell is not aware of the potential handover and does not prepare for the handover. Alternatively, in an instance in which the apparatus is embodied by a network element, the network element may initiate hand over of the mobile terminal to the respective small cell upon determining that the foregoing conditions have been satisfied. In this regard, the network element may have information regarding the application type, e.g., the delay sensitivity of the application executed by the mobile terminal, but may need information from the mobile terminal regarding the speed of the mobile terminal, e.g., the velocity of the mobile terminal. Additionally or alternatively, the network entity may obtain statistics relating to macrocell to femtocell handovers and femtocell to femtocell handovers of the mobile terminal, either from the mobile terminal or from the network as a key performance indicator (KPI). The method, apparatus and computer program product of some example embodiments of the present invention may include one or more additional criteria that may allow for a mobile terminal 14 to be handed over to a respective small cell 12 if any one of the other criteria is satisfied. In blocks 46 and 48 of FIG. 3B, for example, the apparatus 20, such as the processor 22, may initially determine the speed and/or mobility state of the mobile terminal and may then determine whether the speed of the mobile terminal satisfies a speed threshold or whether the mobility state of the mobile terminal satisfies a predefined criteria, such as described above in conjunction with blocks 32 and 37. In an instance in which the speed with which the mobile terminal is moving fails to satisfy the speed threshold, such as by being smaller than the speed threshold, and the mobility state of the mobile terminal fails to satisfy the predefined criteria, the apparatus may include means, such as the processor, the communication interface 26 or the like, for causing initiation of a hand over of the mobile terminal to a respective small cell. See block 50 of FIG. 3B. In this regard, the mobile terminal may be handed over to the small cell since the mobile terminal is moving slowly enough so as not to cause any meaningful risk that the mobile terminal will quickly move outside the cell area of the small cell and require a further hand over, such as a hand over to the macro cell, which may, in turn, create the risk of a connection gap or a radio link failure.

In an instance in which the speed of the mobile terminal 14 satisfies the speed threshold or the mobility state of the mobile terminal satisfies the predefined criteria, the apparatus 20 of another embodiment may include means, such as the processor 22 or the like, for determining, such as by reference to the connection history stored by memory 24, whether the mobile terminal has detected a small cell 12 to which the mobile terminal has previously been unsuccessfully connected and, if so, if at least a predefined time period has elapsed since the prior unsuccessful connection. See block 56 of FIG. 3B. If so, the apparatus, such as the processor, the communication interface 26 or the like, may be configured to cause initiation of a hand over of the mobile terminal to the respective small cell. See block 50 of FIG. 3B. Alternatively, if a predefined time period has not elapsed, the apparatus may not cause the initiation of a hand over and the mobile terminal may, instead, continue to be supported by a macro cell 10. See block 54 of FIG. 3B.

In a further embodiment in which the speed of the mobile terminal 14 satisfies the speed threshold or the mobility state of the mobile terminal satisfies the predefined criteria, the apparatus 20 may include means, such as a processor 22 or the like, for determining whether the mobile terminal has detected a small cell 12 to which the mobile terminal has not previously connected, at least not within the stored connection history, and, if so, may determine whether a connection and/or handover to the respective small cell and its neighboring small cell(s) would have been successful in the past, such as based upon inter-frequency measurements and/or femtocell to femtocell handover statistics. See block 58 of FIG. 3B. In an instance in which a connection with and/or handover to the respective small cell would have been successful in the past even though no connection has previously been established with the small cell and its neighboring small cell(s), at least not within the stored connection and/or handover history, the apparatus, such as a processor, the communication interface 26 or the like, may cause the initiation of a hand over of the mobile terminal to the respective small cell. See block 50 of FIG. 3B. However, if a connection and/or a handover to the respective small cell and its neighboring small cell(s) would not have been successful in the past, the apparatus may not cause initiation of a hand over and the mobile terminal may, instead, continue to be supported by a macro cell 10. See block 54 of FIG. 3B.

In an instance in which the speed of the mobile terminal 14 satisfies the speed threshold or the mobility state of the mobile terminal satisfies the predefined criteria, the apparatus 20 of another embodiment may include means, such as the processor 22 or the like, for determining the ratio of successful and unsuccessful prior connections and/or handovers to a respective small cell 12. In instances in which the ratio of successful to unsuccessful prior connections and/or handovers to the respective small cell and its neighboring small cell(s) exceeds a predefined threshold, such as by being greater than 1:1, the apparatus may include means, such as the processor, the communication interface 26 or the like, for causing the initiation of the hand over from the mobile terminal to the respective small cell. See blocks 60 and 50 of FIG. 3B. Alternatively, in an instance in which the ratio of prior successful connections to unsuccessful connections falls below the predefined threshold, the apparatus may not cause the initiation of a hand over and the mobile terminal may, instead, continue to be supported by a macro cell 10. See block 54 of FIG. 3B.

By controlling the instances in which a mobile terminal 14 is handed over from a macro cell 10 to a respective small cell 12, such as a respective small cell operating on a different frequency layer, the method, apparatus 20 and computer program product of an example embodiment may reduce the risk that a connection gap or radio link failure will occur by permitting the mobile terminal to be supported by multiple small cells in order to defer any subsequent handover from a small cell to a macro cell. In particular, the method, apparatus and computer program product of an example embodiment may, in some instances, control the hand over of a mobile terminal to a respective small cell depending upon the speed with which the mobile terminal is moving so as to avoid connection gaps or radio link failure that may occur upon a subsequent hand over from the small cell to a macro cell, such as in an instance in which a quickly moving mobile terminal moves beyond the cell area of the respective small cell. Thus, the user experience may be improved, while still permitting offloading of high data rate or other services in those instances in which it is anticipated that the mobile terminal may continue to be supported by one or small cells for the foreseeable future.

FIGS. 3A and 3B are flowcharts of a method and program product according to an example embodiment of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 24 of a mobile terminal 14 or network element and executed by a processor 22 in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts blocks. These computer program instructions may also be stored in a computer-readable memory that may direct a computer or other programmable apparatus to function in a particular manner, such that the instructions stored in the computer-readable memory produce an article of manufacture which implements the functions specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1-28. (canceled)

29. A method comprising:
determining a speed with which a mobile terminal is moving or a mobility state of the mobile terminal;
determining whether at least a predefined plurality of small cells are available in proximity to the mobile terminal or whether a successful connection or handover was previously established with a small cell or one or more of its neighboring small cells; and
in an instance in which the mobile terminal is moving with a speed that satisfies a speed threshold or in which the mobility state satisfies a predefined criteria, causing initiation of a handover of the mobile terminal to a respective small cell only in an instance in which at least the predefined plurality of small cells are determined to be available in proximity to the mobile terminal or in an instance in which a successful connection or handover was previously established with the respective small cell or one or more of its neighboring small cells.

30. A method according to claim 29 further comprising defining the speed threshold based upon a size of the respective small cell.

31. A method according to claim 29 further comprising defining the speed threshold based upon a minimum connection time.

32. A method according to claim 29 wherein the small cells comprise femtocells, picocells, microcells, home node Bs or home evolved node Bs.

33. A method according to claim 29 further comprising, for an application executing upon the mobile terminal, determining at least one of a sensitivity of the application to delay or an anticipated service time for the application, wherein causing initiation of the handover of the mobile terminal is also based upon a determination of at least one of a sensitivity of the application to delay or an anticipated service time for the application.

34. A method according to claim 29 further comprising causing initiation of a handover of the mobile terminal to a respective small cell in an instance in which at least a predefined time period has elapsed since an unsuccessful connection or handover was previously established with the respective small cell and one or more of its neighboring small cells.

35. A method according to claim 29 further comprising causing initiation of a handover of the mobile terminal to a respective small cell in an instance in which a ratio of a number of successful connections or handovers that were previously established with the respective small cell and one or more of its neighboring small cells to a number of unsuccessful connections and/or handovers that were previously established with the respective small cell and one or more of its neighboring small cells satisfies a predefined threshold.

36. A method according to claim 29 further comprising causing initiation of a handover of the mobile terminal to a respective small cell in an instance in which a connection with or a handover to the respective small cell and one or more of its neighboring small cells would have previously been successful even though no connection or handover with the respective small cell has previously been established.

37. A method according to claim 29 wherein causing initiation of a handover comprises causing a report to be issued to a network element that identifies the respective small cell.

38. An apparatus comprising at least one processor and at least one memory including computer program code, the at least one memory and the computer program code configured to, with the at least one processor, cause the apparatus at least to:
determine a speed with which a mobile terminal is moving or a mobility state of the mobile terminal;
determine whether at least a predefined plurality of small cells are available in proximity to the mobile terminal or whether a successful connection or handover was previously established with a small cell or one or more of its neighboring small cells; and
in an instance in which the mobile terminal is moving with a speed that satisfies a speed threshold or in which the mobility state satisfies a predefined criteria, cause initiation of a handover of the mobile terminal to a respective small cell only in an instance in which at least the predefined plurality of small cells are determined to be available in proximity to the mobile terminal or in an instance in which a successful connection or handover was previously established with the respective small cell or one or more of its neighboring small cells.

39. An apparatus according to claim 38 wherein the at least one memory and the computer program code are further configured to, with the at least one processor, cause the apparatus to define the speed threshold based upon a size of the respective small cell.

40. An apparatus according to claim 38 wherein the at least one memory and the computer program code are further configured to, with the at least one processor, cause the apparatus to define the speed threshold based upon a minimum connection time.

41. An apparatus according to claim 38 wherein the small cells comprise femtocells, picocells, microcells, home node Bs or home evolved node Bs.

42. An apparatus according to claim 38 wherein the at least one memory and the computer program code are further configured to, with the at least one processor, cause the apparatus to determine, for an application executing upon the mobile terminal, at least one of a sensitivity of the application to delay or an anticipated service time for the application, wherein the at least one memory and the computer program code are configured to, with the at least one processor, cause initiation of the handover of the mobile terminal based also upon a determination of at least one of a sensitivity of the application to delay or an anticipated service time for the application.

43. An apparatus according to claim 38 wherein the at least one memory and the computer program code are further configured to, with the at least one processor, cause the apparatus to cause initiation of a handover of the mobile terminal to a respective small cell in an instance in which at least a predefined time period has elapsed since an unsuccessful connection or handover was previously established with the respective small cell and one or more of its neighboring small cells.

44. An apparatus according to claim 38 wherein the at least one memory and the computer program code are further configured to, with the at least one processor, cause the apparatus to cause initiation of a handover of the mobile terminal to a respective small cell in an instance in which a ratio of a number of successful connections or handovers that were previously established with the respective small cell and one or more of its neighboring small cells to a number of unsuccessful connections or handovers that were previously established with the respective small cell and one or more of its neighboring small cells satisfies a predefined threshold.

45. An apparatus according to claim 38 wherein the at least one memory and the computer program code are further configured to, with the at least one processor, cause the apparatus to cause initiation of a handover of the mobile terminal to a respective small cell in an instance in which a connection or a handover with the respective small cell and one or more of its neighboring small cells would have previously been successful even though no connection or handover with the respective small cell and one or more of its neighboring small cells has previously been established.

46. An apparatus according to claim 38 wherein the at least one memory and the computer program code are configured to, with the at least one processor, cause the apparatus to cause initiation of a handover by causing a report to be issued to a network element that identifies the respective small cell.

47. A computer program product comprising at least one non-transitory computer-readable storage medium having computer-executable program code portions stored therein, the computer-executable program code portions comprising program instructions configured to:
determine a speed with which a mobile terminal is moving or a mobility state of the mobile terminal;
determine whether at least a predefined plurality of small cells are available in proximity to the mobile terminal or whether a successful connection or handover was previously established with a small cell or one or more of its neighboring small cells; and
in an instance in which the mobile terminal is moving with a speed that satisfies a speed threshold or in which the mobility state satisfies a predefined criteria, cause initiation of a handover of the mobile terminal to a respective small cell only in an instance in which at least the predefined plurality of small cells are determined to be available in proximity to the mobile terminal or in an instance in which a successful connection or handover was previously established with the respective small cell or one or more of its neighboring small cells.

48. A computer program product according to claim 47 wherein the computer-executable program code portions further comprise program instructions configured to define the speed threshold based upon a size of the respective small cell.
